(19) United States
(12) Patent Application Publication
(10) Pub. No.: US 2023/0386316 A1
(43) Pub. Date: Nov. 30, 2023

(54) SYSTEM AND METHOD TO DETECT A MAN-DOWN SITUATION USING INTRA-AURAL INERTIAL MEASUREMENT UNITS

(71) Applicant: EERS GLOBAL TECHNOLOGIES INC., Montreal (CA)

(72) Inventors: Alex Guilbeault-Sauve, Sainte-Julie, QC (CA); Bruno De Kelper, Laval, QC (CA); Jeremie Voix, Montreal, QC (CA)

(21) Appl. No.: 18/248,955

(22) PCT Filed: Oct. 13, 2021
(86) PCT No.: PCT/CA2021/051438

§ 371 Date: Apr. 13, 2023

Related U.S. Application Data
(60) Provisional application No. 63/091,080, filed on Oct. 13, 2020.

(51) Int. Cl. G08B 21/04; G01P 15/18

(52) U.S. Cl. CPC G08B 21/0446; G08B 21/043; G01P 15/18

(57) ABSTRACT

A system to detect a man down situation using intra-aural inertial measurement units is disclosed. The system comprises an earpiece having an inertial measurement unit (IMU) adapted to capture acceleration and rotation speed of the earpiece. The method comprises a training phase to characterize statistical distribution models of extreme values of feature signals, segmented by their respective optimally-sized time windows and to merge the detection probability provided by the statistical model of the feature signals. The method further comprises a prediction phase. The prediction phase comprises applying the detection strategy on independent data, based on the critical states obtained from the characterization. The data from the said inertial measurement of the MEMS are used for the detection of full (F), immobility (I) and down on the ground (D) states.

### CROSS-REFERENCE TO RELATED APPLICATIONS

The present patent application claims the benefits of priority of U.S. Patent Application No. 63/091,080, entitled “SYSTEM AND METHOD TO DETECT A MAN-DOWN SITUATION USING INTRA-AURAL INERTIAL MEASUREMENT UNITS” and filed at the United States Patent and Trademark Office on Oct. 13, 2020, the content of which is incorporated herein by reference.

### FIELD OF THE INVENTION

The present invention generally relates to systems and methods to detect a man down situation (MDS). More particularly, the present invention relates to systems of using intra-aural inertial measurement to detect an MDS.

### BACKGROUND OF THE INVENTION

Certain areas of industrial workplaces are known to be prone to precariousness and dangers. In such areas, accidents and morbidity are generally more frequent. As examples, mining, forestry, construction and fire-fighting industries represent working environments involving numerous physical and mechanical hazards, as well as lone-work situations. In many countries, labour laws require employers and industries to ensure employee protection in the workplace by adopting preventive measures, appropriate safety equipment and occupational health and safety training. However, no workplace will provide an environment that is or will be totally free of accidents, especially in industries requiring lone workers such as miners, firefighters and forest workers.

In such contexts, workers may wear portable devices in communication with a control center and configured to alert the control center when an emergency situation is detected. When a worker is in an emergency situation or is unable to call for help on his own, either due to loss of consciousness or an incapacitating injury, the system will automatically and advantageously communicate an alert to the control center. Such systems are therefore essential in ensuring occupational health and safety in the workplace, and their reliability is just as critical.

Detection devices are well-known and available on the market. However, current market solutions do not meet industry requirements in terms of reliability, robustness and ease of use since they are plagued by relatively high false-alarm rates, overly long response times and poor ergonomics. The false alarms mostly occur when the device is handled by the worker or when it is not correctly used. Also, the device can hinder the comfort of heavily equipped workers when it must be worn on the belt or chest.

Some of these detection devices use algorithms that take several tens of seconds or even minutes before the emergency is recognized and an alert is sent. These flaws generally result in added costs for employers, a loss of confidence in the technology and lesser deployment of this technology in the industry. According to the Institut de recherche Robert-Sauvé en santé et en securité du travail (IRSST), falls from heights, from same level or from slips constitute the greatest sources of causes of occupational injuries, responsible for more than 21% of occupational injuries during 2010-2012. Compensation paid for injuries in case of falls from heights are larger than the average of other injuries and constitute a significant risk for decreased productivity and losses in quality of life for the victims. Hence, many existing devices are designed to detect falls, but such devices are aimed mostly towards the elderly-care market since the elderly are the population segment most prone and vulnerable to falls. Such research was the subject of numerous studies with 327 studies conducted up until 2013.

Various detection methods have been proposed that use the concept of subject disability after the fall to limit the number of detection errors. Indeed, the observation duration of a disability-state after a fall is a direct factor of fall severity, weakness of the victims and mortality rate, where disability state is mostly characterized by an immobility or down position state. Consequences are then very serious whenever the device fails to detect a fall occurrence, which leads us to consider the post-fall situation as a very important aspect that should be included in a robust fall detection solution.

Some Man Down Situation (MDS) consumer applications are also known in the art for elders using hearing-aid devices. However, very few scientific studies have been done specifically on MDS in the industrial sector and the MDS definitions are not consistent considering the distinction between the different types of emergency situations such as falls, dangerous substance exposure, health problems (stroke, incidents, heart attacks) or loss of consciousness. Some solutions also propose the monitoring of vital signs (respiration, heart rate and galvanic skin response sensors) and several environmental hazards (gas, chemicals, noise) to detect the threat of an emergency situation. This is far more complex, but has the advantage of diagnosing and detecting health problems and environmental hazards as early as possible. This project seeks a global and simple detection solution for all emergency situations faced by workers, since the nature and causes of danger are innumerable, diverse and hard to predict considering the variables: workplace, work tasks, workers' health, physiognomy, etc.

Considering hearing damage caused by prolonged workplace exposure to noise as another major health hazard for workers, there is a need for an improved system and method earpiece to address both these issues with an integrated system and method.

### SUMMARY OF THE INVENTION

The shortcomings of the prior art are generally mitigated a system integrating a man down detection solution into a digital earpiece.

In one aspect of the invention, a digital earpiece comprising an inertial platform and a short-range wireless data communication module, such as a Bluetooth communication module, is provided.

MDS, ranging from workers health-threatening to life-threatening hazards, can occur in high-risk industrial workplaces, especially in isolated working conditions or when worker cannot request assistance while he is disabled, injured or unconscious. MDS automatic detection and warning devices are crucial to help secure a workplace. However, because MDS are not clearly characterized and only few critical conditions are monitored by existing solutions, some problems as multiple false alarms and long response times reduce confidence in this technology and its deployment in the industry. Thus, a global definition of MDS is proposed in this project according to three observable critical states: the worker falls (F), the worker is immobile (I), the worker is down on the ground (D). A detection strategy is established based on combinatorial states F-I, F-D, and I-D, that define MDS as the observation of at least two distinct critical states over a certain period of time. The critical states detection is based on characterization of body movement and orientation data from inertial measurements fusion (accelerometer and gyroscope). The combinatorial states algorithm reveals a significant reduction of the false alarms rate to 1.1% and reaching 99% MDS detection accuracy, results based on a large public database. This project proposes a solution within a digital earpiece designed to address related hearing protection issues for workers, improve overall safety and critical states detection performance.

In another aspect of the invention, a system to detect a man-down situation (MDS) of a person is provided. The system comprises an earpiece comprising an inertial measurement unit (IMU), the IMU capturing data about acceleration and rotation speed of the earpiece and a MDS detection module in data communication with the IMU, the MDS detection module being configured to detect the MDS based on the captured data of the IMU. The IMU may capture three-axis acceleration and rotation of the earpiece. The IMU may further comprise a digital accelerometer and a digital gyroscope. The digital accelerometer may measure acceleration about 3-axis. The measured acceleration may be linear acceleration measurements. The digital gyroscope may measure rotational speed about 3-axis. The rotational speed measurements may be ω=[ωₓ ω_{y} ω_{z}]^{T}. The IMU may be configured to correct the rotational speed measurements by evaluating average rotational speed offset while the gyroscope is stationary.

The IMU may be further configured to measure yaw movements of a wearer of the earpiece.

In a further aspect of the invention, the IMU may further be configured to determine a state of the MDS as a critical state comprised in the following group: fall state (F), immobility state (I), and down position state (D). The system may combine two detected critical states as combinatorial states, the combinatorial states may comprise a combinatorial state F-I being a wearer of the system having fell and remaining inert regardless of the position of the wearer, a combinatorial state F-D being a wearer having fell and remaining lying down on the ground thereafter, and a combinatorial state I-D being the inert wearer lying down on the ground.

In another aspect of the invention, the system may further comprise a database in data communication with the IMU, the database comprising inertial data records of a plurality of activities of daily living (ADL). The earpiece may further comprise a wireless data communication module in communication with the database. The wireless data communication module may transmit the detection status and data from the IMU to a remote computer device. The remote computer device may be configured to post-process orientation and motion tracking captured by the earpiece. The database may further store real-time or live data gathered from the person wearing the earpiece. The system may use the real-time or live gathered data to optimize characterizing of the features and for developing a detection strategy.

In another aspect of the invention, the system may comprise a second earpiece comprising an IMU, the IMU capturing data about acceleration and rotation speed of the second earpiece. The MDS may further be configured to capture inertial measurement from the second earpiece for the detection of fall (F), immobility (I) and down on the ground (D) states.

In one aspect of the invention, a method to detect a man-down situation from in-ear MEMS inertial measurement units is provided. The method may detect a man-down situation (MDS) of a person wearing an in-ear device. The method comprises capturing inertial data about the person using an inertial measurement unit (IMU) of the in-ear device, extracting physical signals from the captured inertial data; determining a combinatory state of the person from the extracted physical signals over a period of time, the combinatory state comprising at least two critical states selected in the group of fall state (F), immobility state (I) and down position state (D), and detecting the man-down situation based on the determined combinatory state. The method may further comprise characterizing body movements of the person using the IMU. The characterization of the body movement of the person may be performed by an accelerometer of the IMU. The method may further comprise characterizing orientation of the person using the IMU. The characterization of the orientation of the person may be based on acceleration and rotational speed measured by the IMU. The characterization of the orientation may use a gradient method.

In another aspect of the invention, the method may further comprise characterizing body movements and orientation of the person using the IMU.

In yet another aspect of the invention, the method may further comprise combining the characterized body movements and orientation of the person to determine the critical states.

The combinatory state may be selected in one of the followings: a combinatorial state F-I being a wearer of the system having fell and remaining inert regardless of the position of the wearer, a combinatorial state F-D being a wearer having fell and remaining lying down on the ground thereafter, and a combinatorial state I-D being the inert wearer lying down on the ground.

The detection of a F critical state may comprise analyzing extreme values of the average of acceleration norms, average of rotational speed norms and average of tilt angle derivatives. The method may further comprise analysing the extreme values of different fall scenarios using time window segmentation.

The detection of a I critical state may comprise measuring minimal body movements over at least a predetermined time period. The detection of a I critical state may further comprise measuring activity level of acceleration, angular velocities and/or derivative of tilt angle.

The detection of a D critical state may comprise measuring a tilt angle of the body of the person. The detection of a I critical state may further comprise analyzing extreme values of the average of tilt angle using:

E_{D}(t,τ_{D})=[(t,τ_{ρ}^{max})]=[max(ρ[t,t+τ_{ρ}^{max}])]
where τ_{D}=[τ_{ρ̅}^{max}] is the size of time window.

In another aspect of the invention, the method of measurement and detection accuracy is improved using binaural redundancy wherein data from the said inertial measurement of the MEMS from the left ear is used for the detection of fall (F), immobility (I) and down on the ground (D) states and is subsequently compared to the inertial measurement of the MEMS from the right ear used for the detection of fall (F), immobility (I) and down on the ground (D) states. For instance, when the comparison result is within an acceptable range, one of the inertial measurements of the MEMS is taken into consideration or an average of the inertial measurements from both left and right MEMS is calculated to determine the measurement. However, when the comparison result is outside the acceptable range, the inertial measurement of the MEMS is ignored and another inertial measurement of the MEMS from both ears may be performed.

In yet another embodiment, a first group of inertial measurements of the MEMS from the left ear is compared to a second group of inertial measurements of the MEMS from the right ear. A comparison of the measurements from the first group and the measurements of the second group is performed to determine the measurement accuracy.

In another aspect of the invention, the method may further comprise capturing inertial data about the person using a second IMS of a second in-ear device for the detection of fall (F), immobility (I) and down on the ground (D) states and comparing the inertial data of the first and the second in-ear devices. The method may further comprise when the comparison is within an acceptable range, calculating a measurement accuracy based on the comparison between the inertial data from the first and the second in-ear devices. Further comprised may be when the comparison is outside an acceptable range, performing another inertial measurement of the IMS of each of the first and second in-ear devices.

The method may further comprise capturing a first group of inertial measurement using the in-ear device for the detection of fall (F), immobility (I) and down on the ground (D) states, capturing a second group of inertial measurement using a second in-ear device, for the detection of fall (F), immobility (I) and down on the ground (D) states and comparing the first group of inertial measurement to the second group of inertial measurement to determine measurement accuracy.

In a further aspect of the invention, the method of measurement and detection accuracy is improved using binaural redundancy.

In yet another aspect of the invention, the method to detect man-down situation uses a combinatorial approach involving F, I and D states

In some other aspect, the method continuously monitors man-down situation using a «flight recorder» approach for database built-up and event assessment.

In a further aspect of the invention, a method to establish a detection model of a man-down situation (MDS) is provided. The method comprises storing inertial measurements of physical signals with regard to extreme values of fall, immobility and down position states as a function of time, training the detection model to identify a detection strategy using the stored inertial measurements, and applying the identified decision strategy on independent data set of physical signals. The training of the detection model may further comprise characterizing statistical distribution models of extreme values of the physical signals as a function of period of time, merging detection probability of the characterized statistical model of the feature signals, determining a threshold to detect the critical states based on the detection probabilities, and combining pairs of detected critical states by time window sizes.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other objects, features and advantages of the invention will become more readily apparent from the following description, reference being made to the accompanying drawings in which:

FIG. 1A is an illustration of an embodiment of a system to detect a man down situation using intra-aural inertial measurement units in accordance with the principles of the present invention.

FIG. 1B is an illustration of an inertial measurement unit (IMU) in accordance with the principles of the present invention.

FIG. 1C is an illustration of another embodiment of a system to detect a man down situation comprising an IMU, a database and in communication with a device in accordance with the principles of the present invention.

FIG. 2 is a Venn diagram presenting the different man down combinations of critical states represented as a function of critical state observations.

FIG. 3 is an embodiment of a digital earpiece used to detect a man down situation using intra-aural inertial measurement in accordance with the principles of the present invention.

FIG. 4(a) to (h) are exemplary diagrams illustrating distributions and estimated statistical model obtained through a detection analysis.

FIG. 5(a) to (h) are exemplary diagrams illustrating detection strategy's performance results of the training phase of the detection algorithms and the parametric analysis.

FIG. 6 are graphs illustrating the summary of the MDS and critical states detection results of an exemplary tests for detecting a MDS using the system of FIG. 1.

FIGS. 8A to 8C are photographs of the different states of an exemplary MDS as a front fall.

FIGS. 8A to 8C are photographs of the different states of an exemplary MDS as a back fall.

### DETAILED DESCRIPTION OF THE PREFERRED EMBODIMENT

A novel system and method to detect a man down situation using intra-aural inertial measurement units will be described hereinafter. Although the invention is described in terms of specific illustrative embodiment(s), it is to be understood that the embodiment(s) described herein are by way of example only and that the scope of the invention is not intended to be limited thereby.

Motion and Orientation Tracking

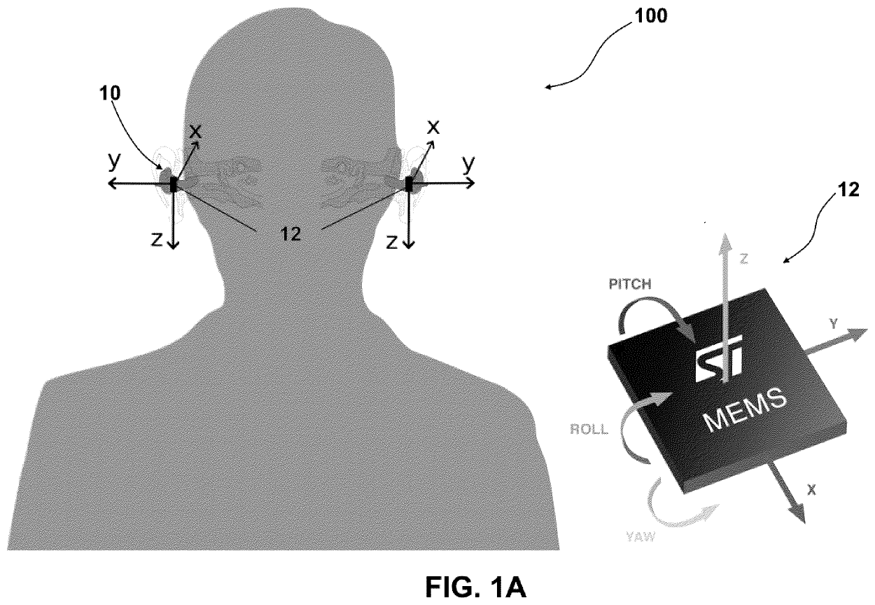

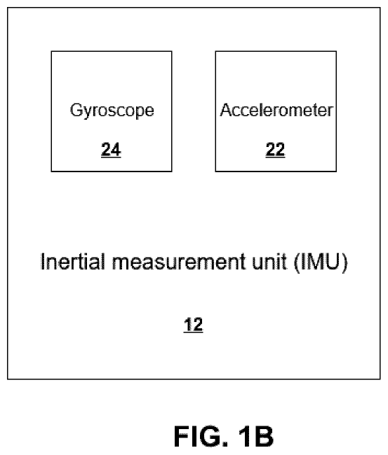

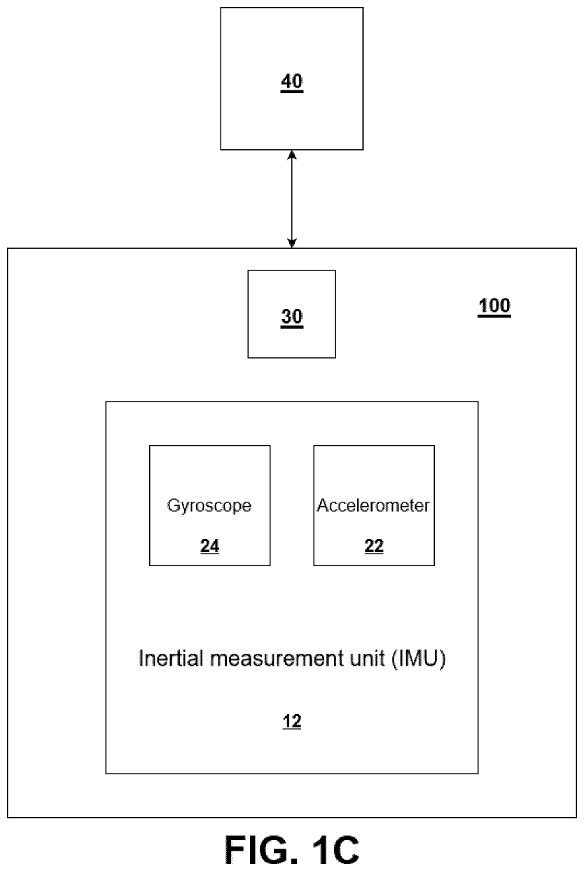

Referring to FIG. 1A, a system to detect a man down situation using intra-aural inertial measurement units 100 is shown. The system 100 comprises an earpiece 10. The earpiece 10 comprises an inertial measurement unit (IMU) 12 adapted to capture acceleration and rotation speed of the earpiece 10. In some embodiments, as shown in FIG. 1B, the IMU 12 may comprise a digital accelerometer 22 and a digital gyroscope 24. As an example, the IMU 12 can be embodied as a LSM6DS3 system manufactured by STMicroelectronics in Huntsville, Alabama. The accelerometer 22 may measure acceleration about 3-axis (x, y, z), such as for linear acceleration measurements α=[αₓ α_{y} α_{z}]^{T}. The gyroscope 24 may also be configured to measure the rotational speed about 3-axis gyroscope, such as for rotational speed measurements ω=[ωₓ ω_{y} ω_{z}]^{T}. The IMU 12 may further be configured to calculate and/or measure pitch, roll and/or yaw movements.

The accuracy of physical sensors, like inertial sensors, may be affected by numerous measurement errors, such as constant error sources due to cross axial coupling, scaling factors, orthogonal axis misalignment and measurement biases. The accuracy may further be affected by continuous errors evolving over time due to random noise processes, including numerical quantification, random gyroscope angle walking, continuous random walk, bias stability, and continuous measurement drift.

In some embodiments, the errors produced by constant error sources are handled by providing unique static calibrations. The errors occurring in a continuous fashion may require additional process and dynamic calibrations that estimate the error variation over usage time. As an example, the error correction may be realized by using an iterative least-squares method to calibrate acceleration measurement. Such method generally does not require external equipment and is based only or mainly on a large acceleration data set of multiple sensor positions.

In one embodiment, by using the direction and magnitude of the Earth's gravity as known and constant parameters, the compensation coefficients of the accelerometer model may be determined and the resulting corrected acceleration vector norm should ideally represent a unitary sphere centered at the origin. The rotational speed instantaneous bias is corrected firstly by a simple static correction obtained by evaluating the average rotational speed offset while the gyroscope is stationary (ω=0). Then, the rotational speed bias drift correction is obtained by integrating the gyroscope's rotational errors with respect to the product of both inertial sensors' measurements and the data fusion of the measurements of said sensors.

To determine an optimal orientation estimation based on the acceleration and on rotational speed, given in quaternion representation, an optimized gradient method, such as the method developed by Madgwick et al (2011), may be used. Such method uses a mathematical entity q=simplifying rotation calculation in space and avoiding the singularity problems of trigonometric functions.

### Database

Referring now to FIG. 1C, the system 100 may further comprise a database 30 comprising inertial data records of a plurality of activities of daily living (ADL).

Understandably, the database 30 may be embodied as any type of database, such as a local or remote database. In some embodiments, the database 30 may be a database hosted on a public server. As an example, the system 100 may be configured to access the database SisFall developed by Sucerquia et al. Again, as an example, such database comprises 4510 inertial data records of various scenarios of activities of daily living (ADL) and falls.

The database 30 is generally used to characterize features and develop a detection strategy. Understandably, the nature of the database 30, such as the database intended to classify fall situations, may not represent all the situations of danger that make up the MDS.

Even if the database 30 is typically used to characterize features and generate a mathematical model, in some embodiments, the database 30 may be used to store real-time or live data gathered from the users of the system 100 during operations for one or both ears. As such, the generated models or even the program to generate the model could be optimized based on said historical data from the users with either single earpiece IMU or binaural earpieces equipped with IMUs.

Features Characterization

The system and method to detect a man down situation using intra-aural inertial generally uses data derived from the IMU 12 of the database 30 to evaluate the probability of an event occurring.

The method comprises capturing inertial data from the IMU 12 and processing the capture inertial data to extract the relevant physical signals to determine the critical states fall (F), immobility (I) and down on the ground (D) states, such as but not limited to the acceleration norm A(t), the rotational speed norm W(t), the tilt angle ρ, from the quaternion estimation, and its derivative \dot{ρ}(t).

$$A ( t ) = ∨ a ( t ) ∨ = \sqrt{{a}_{x}^{2} ( t ) + {a}_{y}^{2} ( t ) + {a}_{z}^{2} ( t )} \\ W ( t ) = ∨ ω ( t ) ∨ = \sqrt{{ω}_{x}^{2} ( t ) + {ω}_{y}^{2} ( t ) + {ω}_{z}^{2} ( t )} \\ ρ = arc cos ( \frac{g \cdot v}{∨ g ∨ ∨ v ∨} ) = arc cos ( g \cdot v ) where v = {q}^{*} gq \\ \dot{ρ} ( t ) = \frac{d ρ ( t )}{dt}$$

The characterization of the feature signals aims at establishing an optimal statistical model, which will serve as a basic index of the detection probability for each critical state. The statistical models are based on the extreme values distribution of the mean or variance of the feature signals segmentation according to different time windows. The temporal means s(t) of a feature signal s(t) and a time window sampling τ is given by

$$\underline{s} ( t , τ ) = \frac{1}{τ} {\int }_{t}^{t + τ} s ( t ) dt$$

then, the temporal sampling variance is given by

$${σ}_{s}^{2} ( t , τ ) = \frac{1}{τ} {\int }_{t}^{t + τ} {( s ( t ) - \underline{s} ( t , τ ) )}^{2} dt .$$

The extreme values of the feature signals are characterized. In some embodiments, the extreme values are characterized using two models of probability distributions. As an example, the two models may be the normal law and the Gumbel's law. The normal law N(μ, σ²) is a continuous probability distribution describing random events of natural phenomena that can be described by two parameters, namely the average pi and the standard deviation a. The probability density function of the random variable X according to the normal law is given by

$${pdf}_{norm} ( X ) = {\frac{1}{σ \sqrt{2 π}}}^{( - \frac{{( x - μ )}^{2}}{2 {σ}^{2}} )} for x ∈ R$$

Gumbel's law, also known as the generalized extreme value distribution of type I (k=1), is a continuous probability distribution G(u, β) commonly used to predict rare events or extreme values of normal-type or exponential initial distribution data. The u and β parameters correspond to the distribution locality and scale, respectively, estimated by the resolution of the equation system given by the maximum likelihood method.

$${pdf}_{gumbel} ( X ) = \frac{1}{β} exp ( \frac{- ( x - u )}{β} exp ( \frac{- ( x - u )}{β} ) ) for x ∈ R ∧ β > 0$$

### Detection Theory

The method generally comprises detecting a man down event using the earpiece. In some embodiments, binary statistical tests or classification theory are used to create the detection model. The binary statistical tests or classification theory generally define a mathematically formalized decision-making method based on known statistical models in order to make a predictive decision using an independent data set. The null hypothesis H₀ defines the decision that the event did not occur and the alternative hypothesis H₁ as the decision that the event did occur. The probability rates of event detection P_{D} when the event actually occurred and the probability rate of a false alarm P_{FA}, also known as the type I error, are defined by the following equations:

P_{D}=Pr{H₁∨H₁}P_{FA}=Pr{H₁∨H₀}

The method comprises calculating or evaluating the detection performance. The calculation of the detection performance comprising identifying the number of “positive” (P) and “negative” (N) results of detection. The method further comprises classifying the results as predetermined categories, such as “true positive” (TP), “false positive” (FP), “true negative” (TN) and “false negative” (FP) as follows their true classification. The accuracy indicates the detection behaviour by evaluating the results of true predictions without considering the classification of the tests.

$$Accuracy = \frac{TP + TN}{P + N}$$

The Matthews correlation coefficient (MCC) is a variable that is commonly used to evaluate the performance of predictive models, especially in personalized medicine (genetic testing, molecular analyzes, etc.), and represents a discretization of the Pearson correlation for the binary classification of two distinct groups that reflects a better evaluation of detection performance over accuracy.

$$MCC = \frac{( TP ) ( TN ) - ( FP ) ( FN )}{\sqrt{( TP + FP ) ( TP + FN ) ( TN + FP ) ( TN + FN )}}$$

In other embodiments, ROC curves or P_{D}/P_{FA} may be used to conduct a performance analysis for the entire detection range (P_{D}∈(0,1)). The MCC constitutes the only variable used in this study to determine optimal time window sizes and critical states detection thresholds.

### Theory—Man Down Situation Definition

The system to detect a MDS may comprise identifying three distinct critical states, namely the immobility state (I), the fall state (F) and down position state (D). The combination of these critical states makes it possible to describe most of the emergency situations faced by workers in industrial workplaces. In the present embodiment, the fall state is defined as the falling phase pre-impact, characterized by a free fall and a large variation of the inclination of the body, and the fall-impact phase, which is generally characterized by a great force resulting from the collision of the body with either the ground or another object. The immobility state is defined as a low level of movement of the worker's body during a significant time period. Finally, the down position state is simply defined by the body's tilt angle. Multiple combinations of these critical states, named combinatorial states, describe a particular set of man down situations:
F-I combinatorial state defines an emergency situation in which a person who has fallen remains inert thereafter, regardless of his final position;
F-D combinatorial state defines an emergency situation in which a person who has fallen remains lying down on the ground thereafter;
I-D combinatorial state defines an emergency situation in which a person is inert and lying down on the ground;

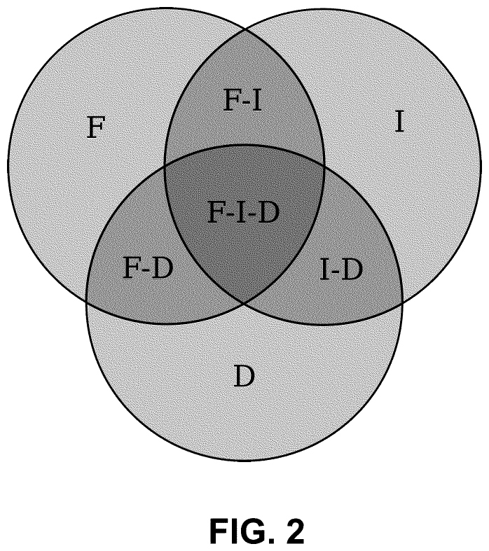

Referring to FIG. 2, a Venn diagram presents the different man down combinations of critical states are represented as a function of critical state observations, summed up in the set (F∩I)∪(F∩D)∪(I∩D). However, the F-I-D combinatorial state is not directly defined since it is already implied in the set of combinatorial states and will not be referred to herein.

### Theory—Detection Algorithms

The characterized extreme values of the feature signals obtained from the inertial measurements constitute the detection strategy variables in regards to the fall, immobility and down position states. The detection strategy consists of several stages of variable processing and analysis in order to train the algorithms and to predict the critical state occurrence.

The method comprises a training phase. The training phase comprises characterizing statistical distribution models of extreme values of feature signals, segmented by their respective optimally-sized time windows. The method further comprises merging the detection probability provided by the statistical model of the feature signals. The method further comprises analyzing the fusion of the detection probability to determine the optimal threshold for the detection of the critical states. The method further comprises applying a simple logic AND function on pairs of detected critical states considering as well the signal segmentation by optimal time window sizes. The application of the AND function resulting in the F-I, F-D and I-D combinatorial states.

The method further comprises a prediction phase. The prediction phase comprises applying the detection strategy on independent data, based on the critical states obtained from the characterization. As an example, considering a given extreme value signal Eₛ(t, τ) of the feature signal s(t) segmented according to a time window size τₛ, as well as a detection threshold γₛ, the detection probability can be found by

$$\begin{matrix}{P}_{D} = {\int }_{{E}_{s} ( t , τ ) max \geq \leq min {γ}_{s}} Pr \{ {E}_{s} ( t , τ ) ∨ {H}_{1} \} {dE}_{s} ( t , τ ) {P}_{FA} \\ = {\int }_{{E}_{s} ( t , τ ) max <> min {γ}_{s}} Pr \{ {E}_{s} ( t , τ ) ∨ {H}_{0} \} {dE}_{s} ( t , τ )\end{matrix}$$

where the detection condition differs depending on the observed extreme value, the minimum (min) or maximum (max) extreme values of the feature signal.

### Fall Detection of Detection Algorithm

The detection of a fall comprises analyzing extreme values of the average of acceleration norms A(t), the average of rotational speed norms W(t) and the average of tilt angle derivatives \dot{ρ}(t). The extreme values of the feature signals are analyzed and studied through the database 30 of different fall scenarios using time window segmentation depending on the transient nature of their signal. Considering the above proposed fall state definition, the extreme values of the fall detection feature signal are given by

$$\begin{matrix}{E}_{F} ( t , {τ}_{F} ) = [ {E}_{\underline{A}}^{min} ( t , {τ}_{\underline{A}}^{min} ) {E}_{\underline{A}}^{max} ( t , {τ}_{\underline{A}}^{max} ) {E}_{\underline{W}}^{max} ( t , {τ}_{\underline{W}}^{max} ) {E}_{\underline{\dot{ρ}}}^{max} ( t , {τ}_{\underline{\dot{ρ}}}^{max} ) ] \\ = [ min ( \underline{A} [ t , t + {τ}_{\underline{A}}^{min} ] ) max ( \underline{A} [ t , t + {τ}_{\underline{A}}^{max} ] ) max ( \underline{W} [ t , t + {τ}_{\underline{W}}^{max} ] ) \\ max ( \underline{\dot{ρ}} [ t , t + {τ}_{\underline{\dot{ρ}}}^{max} ] ) ]\end{matrix}$$

where τ_{F}=[τ_{A}^{min} τ_{A}^{max} τ_{W}^{max} τ_{ρ}^{max}]^{T} are the sizes of the time window.

In the case of fall detection, the transients of different feature signals do not necessarily coincide in time. It is therefore important to apply detection probability fusion over a time window. The fusion function of detection probabilities from the extreme values analysis may be implemented in order to effectively combine the feature's transients, as

$${L}_{F} ( {E}_{F} ( t , {τ}_{F} ) , {τ}_{F , L} ) = {\prod }_{i = 1}^{{M}_{F}} \frac{max ( {pdf}_{i} ( {E}_{F , i} [ t , t + {τ}_{F , L} ] ) )}{max ( {pdf}_{i} )}$$

where M_{F} is the number of feature signals and τ_{F,L} is the time window size.

The expression of the fall state detection signal y_{F} is defined as

$${y}_{F} ( t ) = \{ \begin{matrix}0 & if {L}_{F} ( {E}_{F} ( t , {τ}_{F} ) , {τ}_{F , L} ) \leq {γ}_{F} , \\ 1 & if {L}_{F} ( {E}_{F} ( t , {τ}_{F} ) , {τ}_{F , L} ) > {γ}_{F}\end{matrix} .$$

where γ_{F} is the fall detection threshold.

### Immobility Detection of Detection Algorithm

The definition of a state of immobility implies the observation of minimal body movements over at least a certain time period. The system is configured to identify or detect body movements by measuring an IMU. The detection of body movements may further use the activity level of the acceleration, the angular velocities and/or the derivative of the tilt angle.

In some embodiments, the actual amplitude of detected signals may drift over time. The drifting may ultimately compromise the detection of low levels of movement. Thus, in some embodiments, the system 100 is configured to calculate the variance of the detected signals, aiming at ensuring that the detection properties persist over time. The immobility-state detection is based on the extreme values analysis of feature signals given by

$$\begin{matrix}{E}_{I} ( t , {τ}_{I} ) = [ {E}_{{σ}_{A}^{2}}^{min} ( t , {τ}_{{σ}_{A}^{2}}^{min} ) {E}_{{σ}_{W}^{2}}^{min} ( t , {τ}_{{σ}_{W}^{2}}^{min} ) {E}_{{σ}_{\dot{ρ}}^{2}}^{min} ( t , {τ}_{{σ}_{\dot{ρ}}^{2}}^{min} ) ] \\ = [ min ( {log}_{10} {σ}_{A}^{2} [ t , t + {τ}_{{σ}_{A}^{2}}^{min} ] ) min ( {log}_{10} {σ}_{W}^{2} [ t , t + {τ}_{{σ}_{W}^{2}}^{min} ] ) \\ min ( {log}_{10} {σ}_{\dot{ρ}}^{2} [ t , t + {τ}_{{σ}_{\dot{ρ}}^{2}}^{min} ] ) ]\end{matrix}$$

where τ_{I}=[τ_{σ}_{_{A}}_{²}^{min} τ_{σ}_{_{W}}_{²}^{min} τ_{σ}_{_{ρ}}_{²}^{min}]^{T} are the sizes of the time windows. Since the immobility state is constant and non-transitory, the fusion function is defined by the product of the average detection probabilities, as

$${L}_{I} ( {E}_{I} ( t , {τ}_{I} ) , {τ}_{I , L} ) = {\prod }_{i = 1}^{{M}_{I}} \frac{mean ( {pdf}_{i} ( {E}_{I , i} [ t , t + {τ}_{I , L} ] ) )}{max ( {pdf}_{i} )}$$

where M_{I} is the number of feature signals and τ_{I,L} is the time window size of the feature signals fusion. The expression of the immobility detection status signal is defined as

$${y}_{I} ( t ) = \{ \begin{matrix}0 & if {L}_{I} ( {E}_{I} ( t , {τ}_{I} ) , {τ}_{I , L} ) \leq {γ}_{I} , \\ 1 & if {L}_{I} ( {E}_{I} ( t , {τ}_{I} ) , {τ}_{I , L} ) > {γ}_{I}\end{matrix} .$$

where γ_{I} is the immobility state detection threshold.

### Down Detection of Detection Algorithm

The body tilt angle variable is commonly used in fall detection algorithms to eliminate most of the false positive results, by monitoring the vertical to horizontal transition of the body position (0° to 90°), where the post-impact stage of a fall event is defined by a critical tilt angle value. Considering that a MDS does not necessarily involve a fall, the tilt angle variable is only used for down position state detection. The extreme values analysis of the average maximum of the tilt angle feature signal is given by

E_{D}(τ,τ_{D})=[(t,τ_{ρ}^{max}]=[max(ρ[t,t+τ_{ρ}^{max}])]

where is the size of the time window. The interpretation of E_{ρ}^{max} data can be altered by several unknown factors such as ground level, infrastructures, etc. Thus, the down detection threshold is generally chosen to allow more flexibility by setting the type II error rate to 1% or P_{D}=0.99. The function of down position state y_{D}(t) is defined by

$${y}_{D} ( t ) = \{ \begin{matrix}0 & if {E}_{\overline{ρ}}^{max} ( t , {τ}_{\overline{ρ}}^{max} ) \leq {γ}_{D} , \\ 1 & if {E}_{\overline{ρ}}^{max} ( t , {τ}_{\overline{ρ}}^{max} ) > {γ}_{D}\end{matrix} .$$

where γ_{D} is the down position state detection threshold.

Man Down Detection of Detection Algorithm

The present invention aims at generalizing the emergency situations according to the combination of observed independent critical states, such as the combinatorial states. Indeed, the present invention provides observing or detecting a set of at least two critical states to conclude an MDS. The combinatorial states detection is defined by the logical fusion of pairs of critical state detection signals, using an AND operation as follow:

y_{F-D}(t)=∨{y_{F}[t,t+τ_{F-D}]}∧∨{y_{D}[t,t+τ_{F-D}]}

y_{F-I}(t)=∨{y_{F}[t,t+τ_{F-I}]}∧∨{y_{I}[t,t+τ_{F-I}]}

y_{I-D}(t)=∨{y_{I}[t,t+τ_{I-D}]}∧∨{y_{D}[t,t+τ_{I-D}]}

The method further comprises detecting pairs of critical state detection signals during a predetermined period of time, such as by being segmented by the time windows τ_{F-D}, T_{F-I} and τ_{I-D} specific to each combinatorial state. In some embodiments, the independent detection of critical states is determined by the observation of at least one state detection over the predetermined period of time. Thus, the MDS prediction is defined as the inclusive disjunction of the combinatorial states, expressed as a logical OR operator over the combinatorial states detection signals, as

y_{MDS}(t)=y_{F-D}(t)∨y_{F-I}(t)∨y_{I-D}(t).

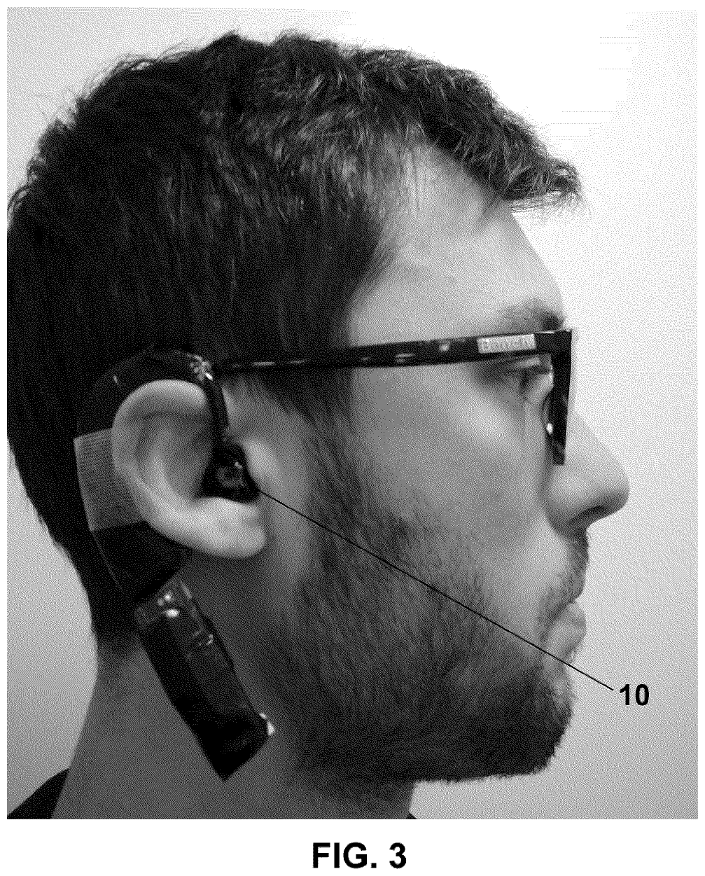

Now referring to FIG. 3, an embodiment of a digital earpiece 10 used with the system 100 is shown. The digital earpiece 10 comprises a wireless data communication module 14, such as a Bluetooth® wireless module. The wireless data communication module 14 enables the transmission of the detection status and data from the IMU 12 to a remote computer device as shown in FIG. 1C. The remote computer device 40 is generally configured to post-process the orientation and motion tracking captured by the digital earpiece 10.

In some embodiments, the IMU 12 is configured to provide inertial data at a predetermined frequency, such as but not limited to 100 Hz, which is half the frequency used by the reference SisFall database.

### Example

The SisFall comprises different fall scenarios, such fall scenarios are used to characterize the distributions of extreme values of each critical state feature signals since they simulated all three critical states. The Table 1 presents some examples of physical tests protocol which, in some instances, have already been performed in other fall detection studies. In such tests, exemplary equipment used to perform the physical tests included but where not limited to a chair, a flight of stairs, a mattress (≥0.75 m thick), a stick (1.5 m); a ball (0.30 m diameter, kg); and a sled (20 kg).

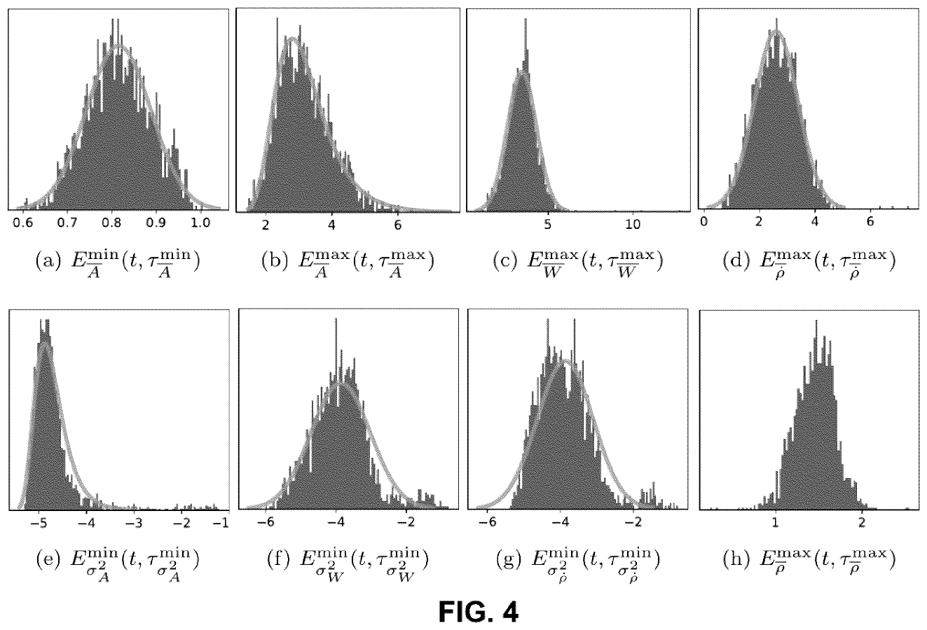

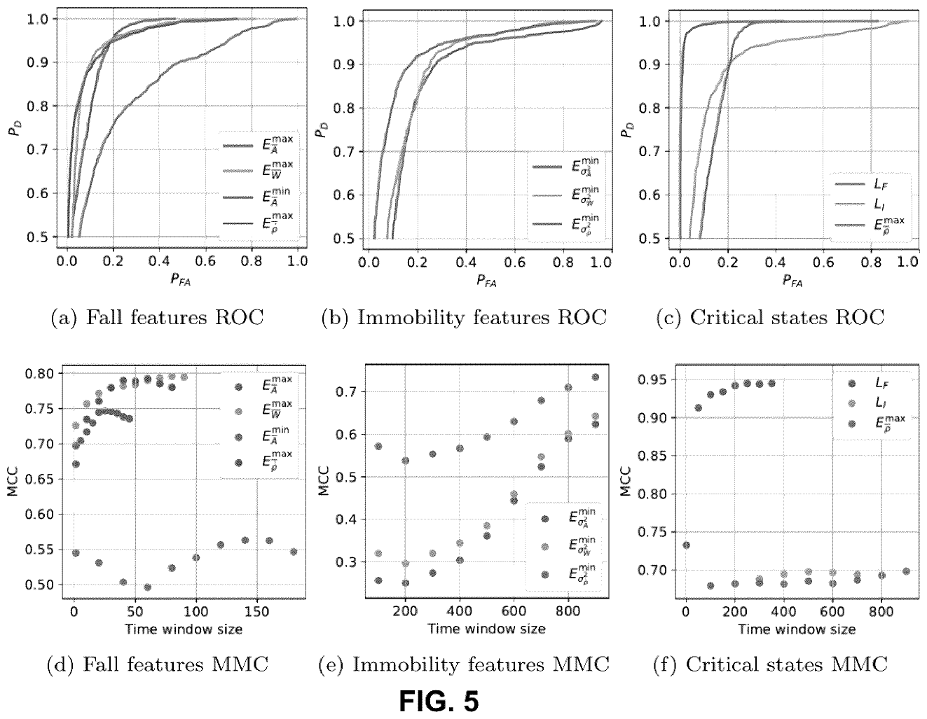

Referring now to FIG. 4, examples of distributions and estimated statistical model obtained through a detection analysis are shown. The model parameters of the present example are presented in Table 2 and the selection of the optimal time windows size according to the maximum MCC values is shown in Table 3. Referring now to FIG. 5, an example of detection strategy's performance results from the training phase of the detection algorithms and the parametric analysis are presented. Table 4 shows the comparison of prediction results of critical states, combinatorial states and MDS on independent tests of the present example. In such example, the performance results and parametric analyses were generated using the 10-fold cross validation method.

TABLE 2
Results of the state features detection characterization

| Signal | Distribution | Locality | Scale |
|---|---|---|---|
| E_{A}^{min} | Normal | μ = 0.821 ± 0.010 | σ = 0.0711 ± 0.0033 |
| E_{A}^{max} | Gumbel | μ = 2.81 ± 0.18 | β = 0.699 ± 0.076 |
| E_{W}^{max} | Normal | μ = 3.435 ± 0.045 | σ = 0.850 ± 0.021 |
| E\dot{_{ρ}^{max}} | Normal | μ = 2.6039 ± 0.0059 | σ = 0.7816 ± 0.0051 |
| E_{σ}_{_{A}}^{2min} | Gumbel | μ = −4.8790 ± 0.0032 | β = 0.2751 ± 0.0046 |
| E_{σ}_{_{W}}^{2min} | Normal | μ = −3.8673 ± 0.0088 | σ = 0.8483 ± 0.0084 |
| E_{σ}{dot over (_{_{ρ}})}^{2min} | Normal | μ = −3.8721 ± 0.0072 | σ = 0.7719 ± 0.0060 |

TABLE 3
Optimal time window sizes (Number of samples)

| | | | |
|---|---|---|---|
| τ_{A}^{min} = 146 ± 10 | τ_{σ}_{_{A}}^{2min} = 900 | τ_{ρ}^{max} = 900 | τ_{F-D} = 960 ± 232 |
| τ_{A}^{max} = 25 ± 3 | τ_{σ}_{_{W}}^{2min} = 900 | τ_{F, L} = 295 ± 44 | τ_{F-I} = 1500 |
| τ_{W}^{max} = 81 ± 3 | τ_{σ}ρ_{_{\dot{ρ}}}L ^{2min} = 900 | τ_{I, L} = 530 ± 67 | τ_{I-D} = 770 ± 48 |
| τ_{ρ}^{max}= 60 | | | |

TABLE 4
States detection prediction results

| State | MCC | Accuracy | P_{D} | P_{FA} |
|---|---|---|---|---|
| F | 0.944 ± 0.019 | 0.9732 ± 0.0090 | 0.966 ± 0.017 | 0.0222 ± 0.0068 |
| I | 0.690 ± 0.026 | 0.850 ± 0.013 | 0.828 ± 0.033 | 0.135 ± 0.023 |
| D | 0.6979 ± 0.0091 | 0.8260 ± 0.0051 | 0.9889 ± 0.0059 | 0.2822 ± 0.0074 |
| F-D | 0.962 ± 0.012 | 0.9814 ± 0.0060 | 0.955 ± 0.016 | 0.0011 ± 0.0018 |
| F-I | 0.830 ± 0.026 | 0.915 ± 0.013 | 0.794 ± 0.031 | 0.0037 ± 0.0042 |
| I-D | 0.843 ± 0.029 | 0.922 ± 0.015 | 0.815 ± 0.034 | 0.0066 ± 0.0059 |
| MDS | 0.9825 ± 0.0080 | 0.9909 ± 0.0037 | 0.9944 ± 0.0037 | 0.0107 ± 0.0053 |

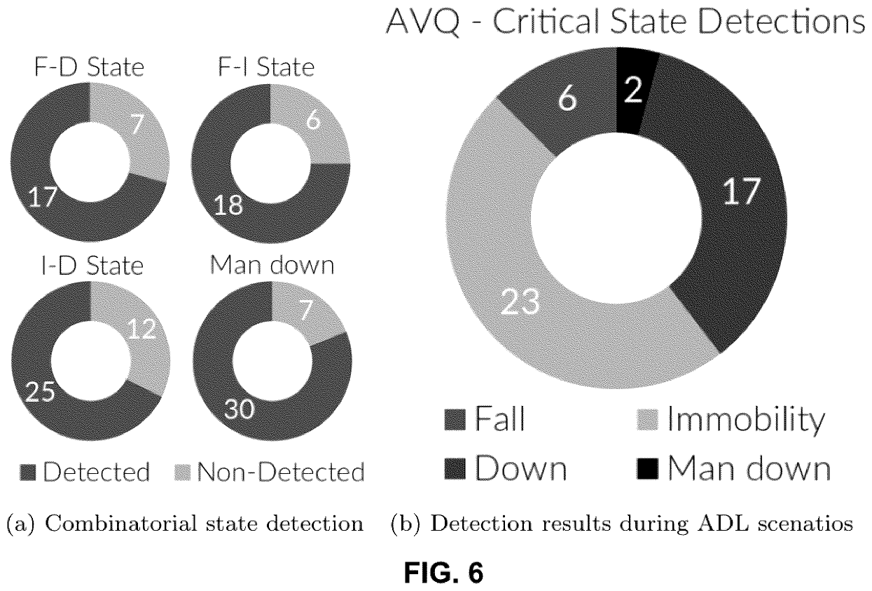

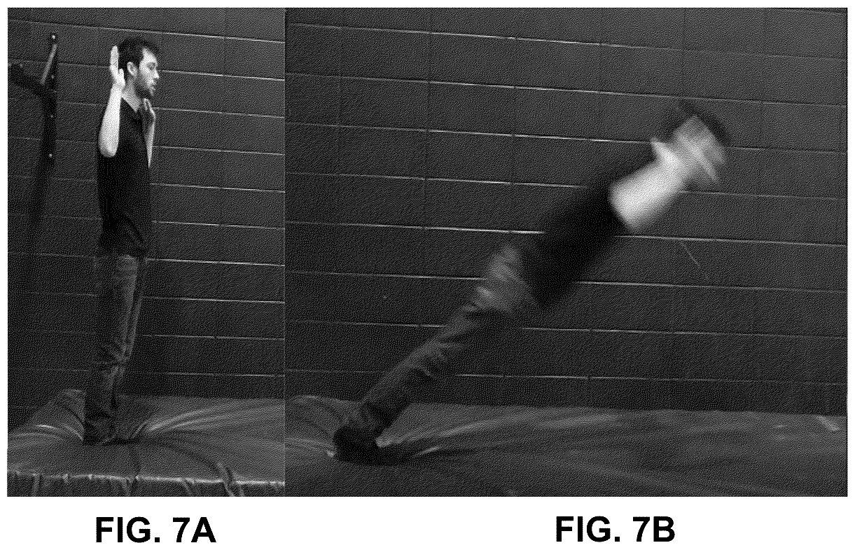

Referring now to FIG. 6, a summary of the MDS and critical states detection results of the above discussed example is shown. During the present example, three volunteers (men between 21 and 25 years old) performed 129 physical test scenarios.

In the present example, the extreme values signal E_{A}^{max} has the shortest transient with an optimal time window size of approximately 125 ms. The other extreme value signals E_{ρ}^{max} E_{W}^{max} and E_{A}^{min} of the fall features have longer optimal time windows of 300 ms, 405 ms and 730 ms, respectively. In such an example, the best detection performance is obtained by E_{ρ}^{max} which also presented the lowest false positive rate, making it the most relevant data for fall state detection. The optimal time windows for the extreme values analysis of immobility state features are all of 900 samples (4.5 seconds), which is the longest window studied considering the finite number of samples from the database inertial measurement records. The parametric analysis demonstrates that since the immobility state is based on non-transitory features, the detection certainty and detection performance increase as a function of the time window size. All feature signals analysis of the immobility state demonstrates similar detection performances although E_{σ}_{_{ρ}}_{²}^{min} has a slightly higher precision rate and MCC. For the down position state, E_{ρ}^{max} has generally longer time windows but has a significant error detection rate as it generally implies large tilt angle positions of some ADL scenarios. In the present example, the average value of E_{ρ}^{max} distribution is 1.451±0.003 radian (≈83°) and the tilt angle threshold is set at radian, or approximately 50 degrees, which sets the detection rate at 99% for the down position state when applied to the fall scenarios in the database 30. The down position state is generally a good indicator of an emergency situation occurrence. In the present example, the false alarm rate was 28.2%. Such false alarm rate may be lowered for MDS detection by using the fusion of critical states detection. In the present example, the F-D combinatorial state has an accuracy rate exceeding 98%. The detection rates of combinatorial states are generally lower than the detection rates of each individual critical state, but the false positive rates of combinatorial states are significantly reduced, generally well below 1%. Critical state fusion is essential to the reduction of the rate of false alarms and the related undesirable impacts (loss of time, loss of confidence and costs), which are the main causes of insufficient deployment of MDS detection systems in the geriatric practice and industrial sectors. In the present example, the effectiveness and reliability of the MDS detection strategy, based on the present invention, is demonstrated by an impressive performance of its overall prediction with precision and detection rates of over 99% as well as a 1.1% false alarm rate.

The time window size is an important, sometimes critical factor, in the detection of the immobility state in order to reduce false positive classifications. As experimented, the detection fusion function reduces the MDS false alarms conditions compared to the individual critical state detection. Thus, the results for combinatorial states and MDS detection also indicate a good overall detection performance, as shown by the detection rate of 81.1% in the above example.

Referring now to FIGS. 7A to 7C, an exemplary MDS as a front fall is illustrated. The illustrated MDS shows the three distinct critical states, namely the immobility state (I) in FIG. 7A, the fall state (F) in FIG. 7B and down position state (D) in FIG. 7C.

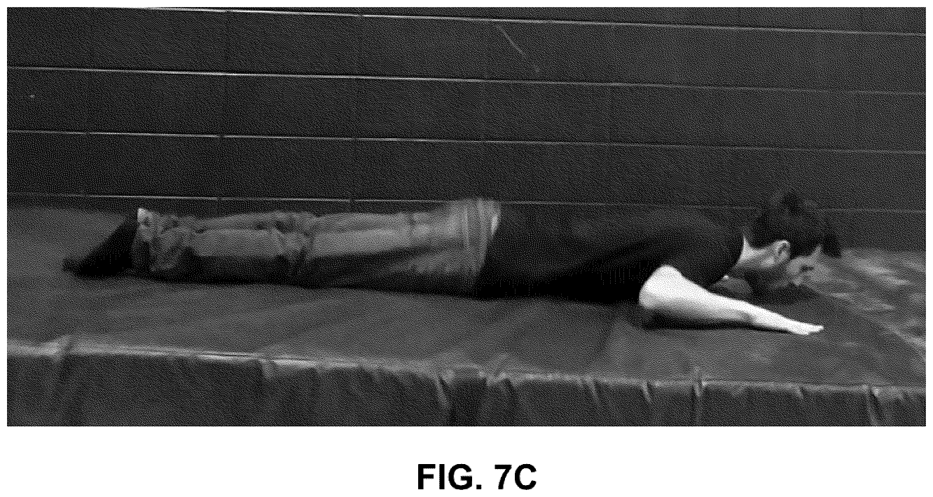

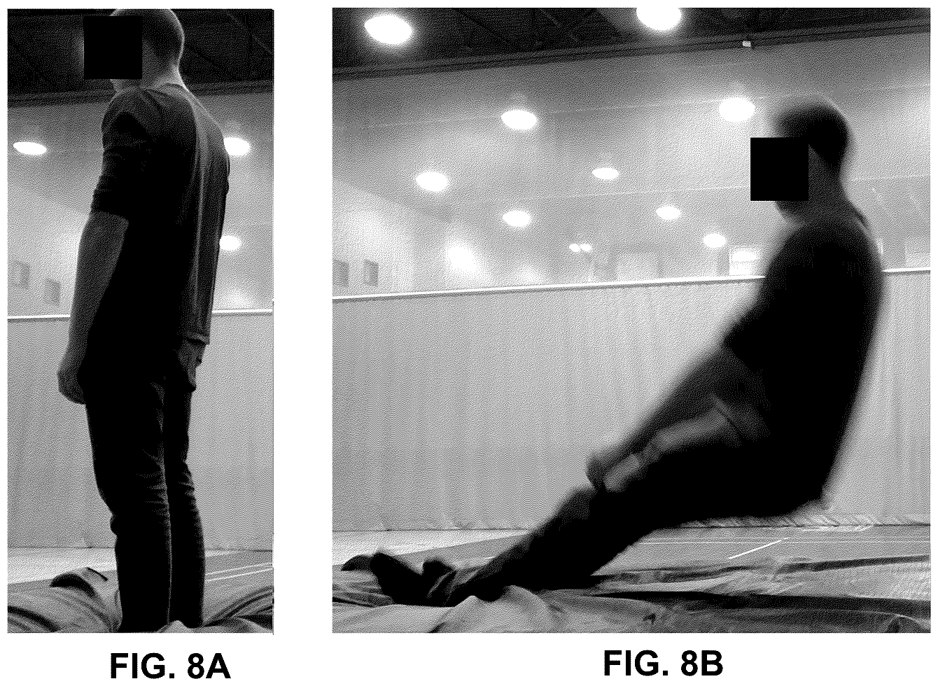

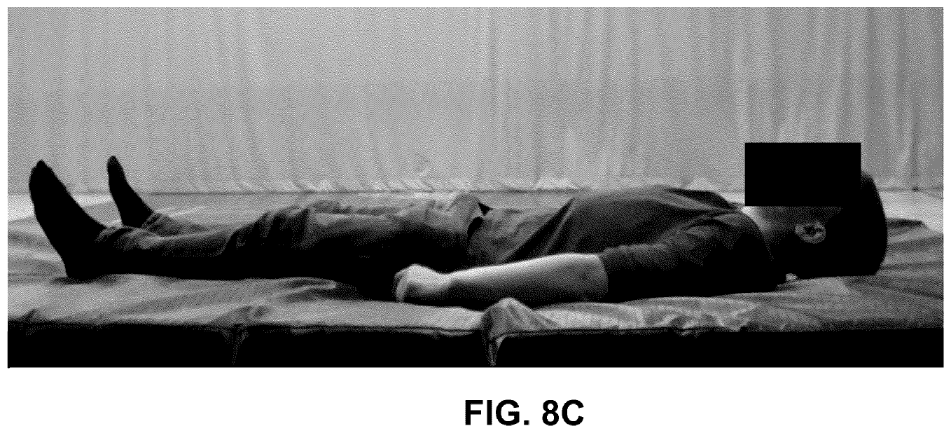

Referring now to FIGS. 8A to 8C, an exemplary MDS as a back fall is illustrated. The illustrated MDS shows the three distinct critical states, namely the immobility state (I) in FIG. 8A, the fall state (F) in FIG. 8B and down position state (D) in FIG. 8C.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A system to detect a man-down situation (MDS) of a person, the system comprising:
an earpiece comprising an inertial measurement unit (IMU), the IMU capturing data about acceleration and rotation speed of the earpiece;
a MDS detection module in data communication with the IMU, the MDS detection module being configured to detect the MDS based on the captured data of the IMU.

2) The system of claim 1, the IMU capturing three-axis acceleration and rotation of the earpiece.

3) The system of claim 1, the IMU further comprising a digital accelerometer and a digital gyroscope.

4) The system of claim 3, the digital accelerometer measuring acceleration about 3-axis.

5) The system of claim 4, the measured acceleration being linear acceleration measurements.

6) The system of claim 3, the digital gyroscope measuring rotational speed about 3-axis.

7) The system of claim 6, the rotational speed measurements being ω=[ωₓ ω_{y} ω_{z}]^{T}.

8) The system of claim 6, the IMU being configured to correct the rotational speed measurements by evaluating average rotational speed offset while the gyroscope is stationary.

9) The system of claim 3, the IMU being configured to measure yaw movements of a wearer of the earpiece.

10) The system of claim 1, the IMU being further configured to determine a state of the MDS as a critical state comprised in the following group:
fall state (F);
immobility state (I); and
down position state (D).

11) The system of claim 10, the system combining two detected critical states as combinatorial states, the combinatorial states comprising:
a combinatorial state F-I being a wearer of the system having fell and remaining inert regardless of the position of the wearer;
a combinatorial state F-D being a wearer having fell and remaining lying down on the ground thereafter;
a combinatorial state I-D being the inert wearer lying down on the ground.

12) The system of claim 1, the system further comprising a database in data communication with the IMU, the database comprising inertial data records of a plurality of activities of daily living (ADL).

13) The system of claim 12, the earpiece further comprising a wireless data communication module in communication with the database.

14) The system of claim 13, the wireless data communication module transmitting of the detection status and data from the IMU to a remote computer device.

15) The system of claim 14, the remote computer device being configured to post-process orientation and motion tracking captured by the earpiece.

16) The system of claim 12, the database further storing real-time or live data gathered from the person wearing the earpiece.

17) The system of claim 16, the system using the real-time or live gathered data to optimize characterizing of the features and for developing a detection strategy.

18) The system of claim 10, the system comprising a second earpiece comprising IMU, the IMU capturing data about acceleration and rotation speed of the second earpiece.

19) The system of claim 18, the MDS being further configured to capture inertial measurement from the second earpiece for the detection of fall (F), immobility (I) and down on the ground (D) states.

20) Method for detecting a man-down situation (MDS) of a person wearing an in-ear device, the method comprising:
capturing inertial data about the person using an inertial measurement unit (IMU) of the in-ear device;
extracting physical signals from the captured inertial data;
determining a combinatory state of the person from the extracted physical signals over a period of time, the combinatory state comprising at least two critical states selected in the group of fall state (F), immobility state (I) and down position state (D);
detecting the man-down situation based on the determined combinatory state.

21) The method of claim 20, the method further comprising characterizing body movements of the person using the IMU.

22) The method of claim 21, the characterization of the body movement of the person being performed by an accelerometer of the IMU.

23) The method of claim 20, the method further comprising characterizing orientation of the person using the IMU.

24) The method of claim 23, the characterization of the orientation of the person being based on acceleration and rotational speed measured by the IMU.

25) The method of claim 24, the characterization of the orientation using a gradient method.

26) The method of claim 20, the method further comprising characterizing body movements and orientation of the person using the IMU.

27) The method of claim 26, the method further comprising combining the characterized body movements and orientation of the person to determine the critical states.

28) The method of claim 20, the combinatory state being selected in one of the followings:
a combinatorial state F-I being a wearer of the system having fell and remaining inert regardless of the position of the wearer;
a combinatorial state F-D being a wearer having fell and remaining lying down on the ground thereafter; and
a combinatorial state I-D being the inert wearer lying down on the ground.

29) The method of claim 20, the detection of a F critical state comprising analyzing extreme values of the average of acceleration norms, average of rotational speed norms and average of tilt angle derivatives.

30) The method of claim 29, the method further comprising analysing the extreme values of different fall scenarios using time window segmentation.

31) The method of claim 20, the detection of a I critical state comprising measuring minimal body movements over at least a predetermined time period.

32) The method of claim 31, the detection of a I critical state further comprising measuring activity level of acceleration, angular velocities and/or derivative of tilt angle.

33) The method of claim 20, the detection of a D critical state comprising measuring a tilt angle of the body of the person.

34) The method of claim 33, the detection of a I critical state further comprising analyzing extreme values of the average of tilt angle using:
E_{D}(t,τ_{D})=[(t,τ_{ρ}^{max})]=[max(ρ[t,t+τ_{ρ}^{max}])]
where τ_{D}=[τ_{ρ}^{max}] is the size of time window.

35) The method of claim 20, the method further comprising:
capturing inertial data about the person using a second IMS of a second in-ear device for the detection of fall (F), immobility (I) and down on the ground (D) states;
comparing the inertial data of the first and the second in-ear devices.

36) The method of claim 35, when the comparison is within an acceptable range, calculating a measurement accuracy based on the comparison between the inertial data from the first and the second in-ear devices.

37) The method of claim 35, when the comparison is outside an acceptable range, performing another inertial measurement of the IMS of each of the first and second in-ear devices.

38) The method of claim 20, the method further comprising:
capturing a first group of inertial measurement using the in-ear device for the detection of fall (F), immobility (I) and down on the ground (D) states;
capturing a second group of inertial measurement using a second in-ear device;
for the detection of fall (F), immobility (I) and down on the ground (D) states;
comparing the first group of inertial measurement to the second group of inertial measurement to determine measurement accuracy.

39) A method to establish a detection model of a man-down situation (MDS), the method comprising:
storing inertial measurements of physical signals with regard to extreme values of fall, immobility and down position states as a function of time;
training the detection model to identify a detection strategy using the stored inertial measurements;
applying the identified decision strategy on independent data set of physical signals.

40) The method of claim 39, the training of the detection model further comprising:
characterizing statistical distribution models of extreme values of the physical signals as a function of period of time;
merging detection probability of the characterized statistical model of the feature signals;
determining a threshold to detect the critical states based on the detection probabilities;
combining pairs of detected critical states by time window sizes.
